(19) United States
(12) Patent Application Publication
(10) Pub. No.: US 2012/0268466 A1
(43) Pub. Date: Oct. 25, 2012

(54) Method and System for graphically determining the degree of separation between banks in a correspondent banking network

(76) Inventor: Brian Kolo, Leesburg, VA (US)

(21) Appl. No.: 13/092,893

(22) Filed: Apr. 22, 2011

(51) Int. Cl. G06T 11/20

(52) U.S. Cl. 345/440

(57) ABSTRACT

The present invention discloses a method for determining the minimum degree of separation between two banks using graphical methods. In this method, a graphical representation of the banking network is created where the vertices on the graphs represent banks and the graph edges represent correspondent relationships between banks. Using this graph, the degree of separation of any two banks may be computed as the minimum number of edges in any path linking the two banks.

### BACKGROUND OF THE INVENTION

The Comprehensive Iran Sanctions, Accountability, and Divestment Act of 2010 (CISADA) includes provisions prohibiting a US bank from creating, maintaining, or holding a correspondent bank account with a foreign bank when the foreign bank holds or maintains a correspondent bank account with an illicit Iranian bank.

This regulation places additional compliance regulations on US banks As such, it is important for US banks to investigate foreign banks to determine the degree of separation the US bank has from an illicit bank via a foreign correspondent bank.

### SUMMARY OF THE INVENTION

The present invention is directed toward a graphical means to determine the degree of separation between any two banks via correspondent bank accounts.

The present invention is also directed toward investigating CISADA compliance for a US bank.

The present invention is also directed toward determining which foreign banks are incompatible for US banking relationships.

### BRIEF DESCRIPTION OF THE DRAWINGS

FIG. 1 provides a flowchart for determining US banks that may be in violation of CISADA using graphical methods.

FIG. 2 provides a flowchart for determining foreign banks that would violate CISADA if US correspondent banking relationships are established using graphical methods.

FIG. 3 provides an example of a Bank-Linking Data Source with one directed relationship group.

FIG. 4 provides an example of a Bank-Linking Data Source with two directed relationship groups.

FIG. 5 provides an example of a Bank-Linking Data Source with one undirected relationship group.

FIG. 6 provides an undirected graph of the Bank-Linking Data Source of FIG. 5.

FIG. 7a provides a directed graph of the vostro relationship group found in the Bank-Linking Data Source of FIG. 4.

FIG. 7b provides a directed graph of the nostro relationship group found in the Bank-Linking Data Source of FIG. 4.

FIG. 8 provides a directed bipartite graph of the nostro relationship group found in the Bank-Linking Data Source of FIG. 4.

FIG. 9 provides an undirected bipartite graph of the relationship group of the Bank-Linking Data Source from FIG. 5.

FIG. 10 provides an example of bridge banks in an undirected graph of a relationship group in a Bank-Linking Data Source.

Particular embodiments of the present invention will now be described in greater detail with reference to the figures.

### PREFERRED EMBODIMENTS

Several embodiments and capabilities may be useful and the instant invention may be modified in a variety of ways. In this section these additional embodiments are detailed.

Embodiment features disclosed in this section may be used to augment or modify the previous embodiments, but nothing in this section is required for operation of the invention.

In addition, aspects of the embodiments disclosed in this section may be combined together to create integrated or aggregated inventions employing the various features and capabilities.

### Bank-Linking Data Source

A Bank-Linking Data Source is a source of information pertaining to banks that indicates zero, one, or more relationships between the banks. The relationship may be directional in nature. For example, one bank may have an account with a second bank. Here, the relationship is directional because the type of relationship the first bank has with the second (account owner) is different than the relationship the second has with the first (account holder).

Correspondent banking may give rise to a directional relationship in a Bank-Linking Data Source. For example, suppose a first bank has a correspondent bank account with a second bank. Here, the first bank has a nostro relationship with the second bank. The term ‘nostro’ indicates that the first bank owns the account held at the second bank. A nostro correspondent account holder is a bank that owns or controls an account held at a second bank.

Conversely, the second bank is a vostro for the first bank. The term ‘vostro’ indicates that the second bank has an account at the second bank that is owned or controlled by the first bank.

As an example of a Bank-Linking Data Source, consider a data source that include a list of banks, wherein each bank is associated with one or more banks in a correspondent relationship including a list of nostro accounts (accounts held by the bank at other banks as well as a list of vostro accounts (accounts held by the first bank that are owned or controlled by other banks). In this example, the data source includes bank information that links different banks and would be considered a Bank-Linking Data Source.

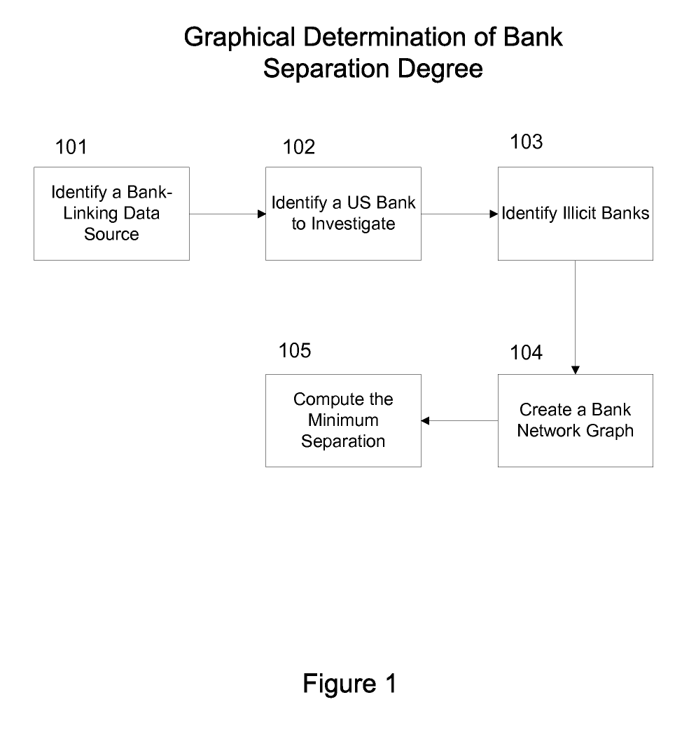

FIG. 1 depicts a flowchart for determining when a US bank may be violating CISADA regulations using graphical methods. First, a Bank-Linking Data Source is identified (101). Second, the US bank under consideration is identified (102). Next, the set of illicit banks is identified (103). Then, a Bank Network Graph (104) is created. The bank network graph is a graph where the vertices on the graph represent banks, and two vertices are connected if there is a correspondent banking relationship between the corresponding banks. Alternatively, the Bank Network Graph may include arrows indicating whether the correspondent banking relationship is a nostro or vostro relationship. For example, a nostro relationship may be indicated by an arrow on an edge where the arrowhead points toward the bank holding the account. Similarly, a vostro relationship is indicated by an arrowhead pointing away from the account owner. From the Bank Network Graph, the minimum degree of separation is computed (105) between the US bank and each illicit bank. The degree of separation between any two banks is the minimum number of edges that must be traversed when going from the US bank to an illicit bank.

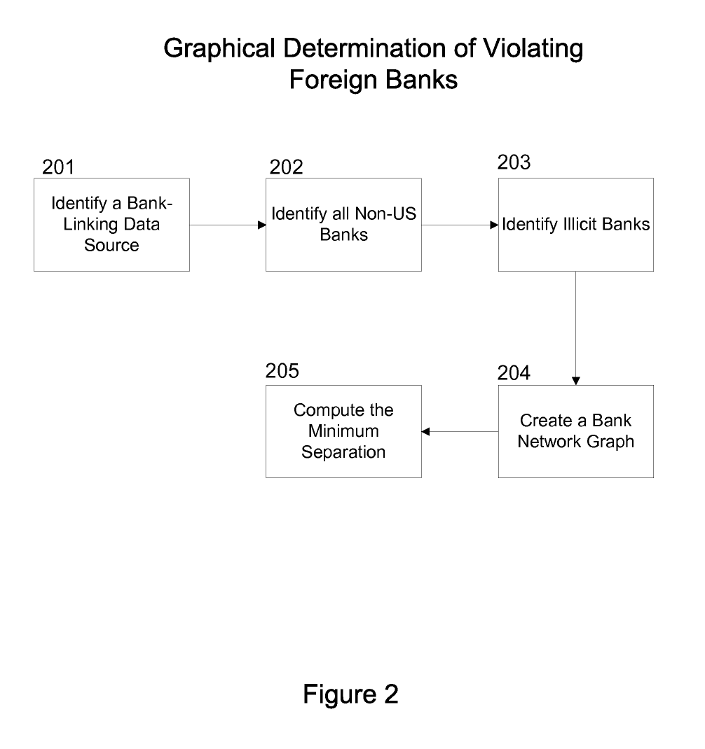

FIG. 2 provides a flowchart for determining foreign banks that may cause CISADA violations if a US bank were to enter into a correspondent banking relationship with the foreign bank. First, a Bank-Linking Data Source is identified (201). Next, all non-US banks in the Bank-Linking Data Source are identified (202). Then all illicit banks of interest are identified (203). Next, a Bank Network Graph is created in the same manner as described above (204). Finally, the minimum separation between each foreign bank and each illicit bank is computed (205). Any foreign bank that is separated at one degree from an illicit bank may cause a CISADA violation if a US bank were to enter into a correspondent banking relationship with the foreign bank.

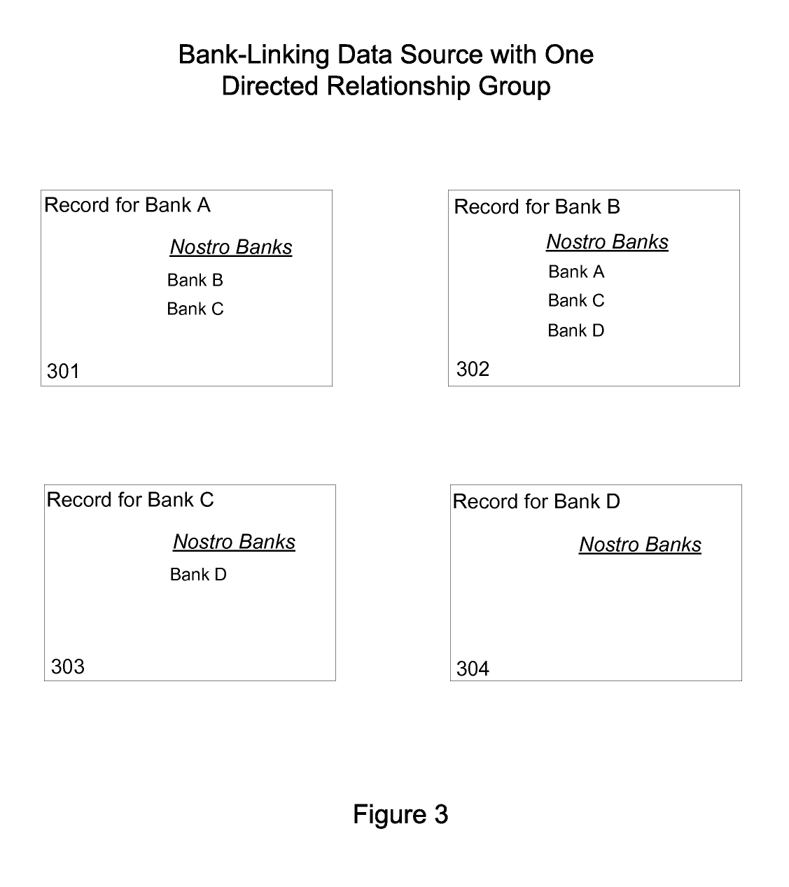

FIG. 3 depicts an example of a Bank-Linking Data Source with one directed relationship. The relationship in this example is a nostro relationship. The record for Bank A (301) indicates that Bank A has a nostro relationship with Bank B and Bank C. Furthermore, the record for Bank B (302) indicates that Bank B has a nostro relationship with Bank A, Bank C, and Bank D. Next, the record for Bank C (303) indicates that Bank C has a nostro relationship with Bank D. Finally, the record for Bank D (304) indicates that Bank D does not have a nostril relationship with any other bank.

### Directed and Undirected Relationship Groups

A Bank-Linking Data Source may have one or more relationship groups. Each relationship in the group may have zero, one, or more relationships between a given bank and other banks.

For example, a Bank-Linking Data Source may have a relationship group for nostro relationships and a relationship group for vostro relationships. In this data source, each bank has a list of banks under a nostro relationship, and each bank has a separate list of banks under a vostro relationship.

A relationship group may be directed or undirected. In a directed relationship group, when a first bank is on the relationship list for the second bank, it is not necessarily true that the second bank is on the relationship list of for the first bank. These types of relationships are directional in nature. For example, a Bank-Linking Data Source may contain a list of banks and the relationship group may be a list of banks owned by a given bank. Here, if Bank A owns Bank B, the entry for Bank A in the Bank-Linking Data Source would indicate a relationship to Bank B in the ‘owns’ relationship group.

However, in the same Bank-Linking Data Source, the entry for Bank B would not indicate a relationship to Bank A in the ‘owns’ relationship group. Since Bank B does not own Bank A, the Bank-Linking Data Source should not have this entry in the ‘owns’ relationship group for Bank B.

Alternatively, the relationship group may be undirected. This is often the case when the relationship is bidirectional in nature. In undirected relationships, when a first bank is on the relationship list of a second bank, the second bank is also on the relationship list for the first bank.

For example, a Bank-Linking Data Source may have a relationship group indicating banks that are in the same country. Here, if Bank A is on the ‘in country’ relationship group of Bank B, it is expected that Bank B should be on the ‘in country’ relationship of Bank A.

It should be appreciated that a Bank-Linking Data Source may have a plurality of relationship groups. Moreover, some relationship groups may be directed, while other relationship groups may be undirected.

FIG. 3 provides an example of a Bank-Linking Data Source with a directed relationship group. Here, the relationship group is a nostro relationship. From the figure, the record for Bank A (301) indicates that Bank A has a nostro relationship with Bank C. However, the record for Bank C (303) does not indicate a nostro relationship with Bank A. Here, the nostro relationship is directional. Thus, a first bank may appear on the relationship for a second bank, but the second bank does not appear on the relationship list of the first bank.

Further examining FIG. 3, the record for Bank A (301) indicates a nostro relationship with Bank B. Moreover, the record for Bank B (302) indicates a nostro relationship with Bank A. In this particular case, both of these banks appear on the other banks nostro relationship list. Thus, even though the relationship is directed, it is possible that a particular relationship between two banks may exhibit undirected characteristics.

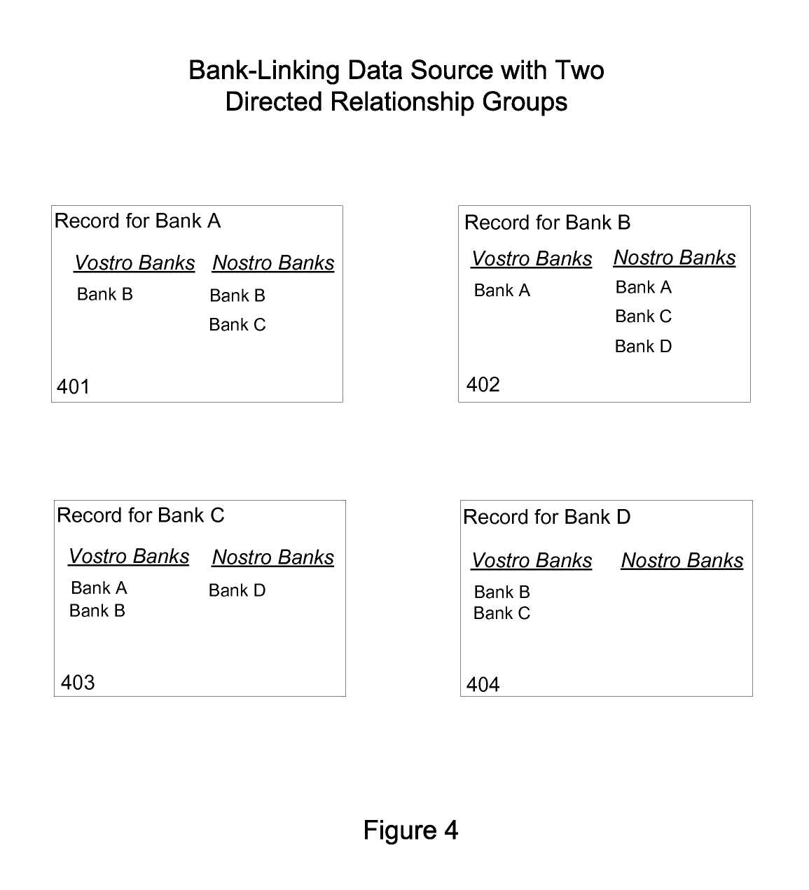

FIG. 4 shows an example of a Bank-Linking with two directed relationship groups. The records for the banks in this FIG. 401-404) have two different relationship groups. Each record has a relationship list for vostro relationships, and a relationship list to nostro relationships.

In FIG. 4, the record for Bank A (401) has both a vostro and nostro relationship list. In the vostro relationship list for Bank A (401), Bank B appears on the vostro list. In the nostro relationship list for Bank A (401), Bank B and Bank C both appear on this nostro list. Similarly, the record for Bank B (402) indicates Bank A on the vostro list, while Bank A, Bank C, and Bank D appear on the nostro list. Alternatively, the record for Bank C (403) has a vostro list containing Bank A and Bank B, while the nostro list contains Bank D. Finally, the record for Bank D has Bank B and Bank C on the vostro list while the nostro list is empty.

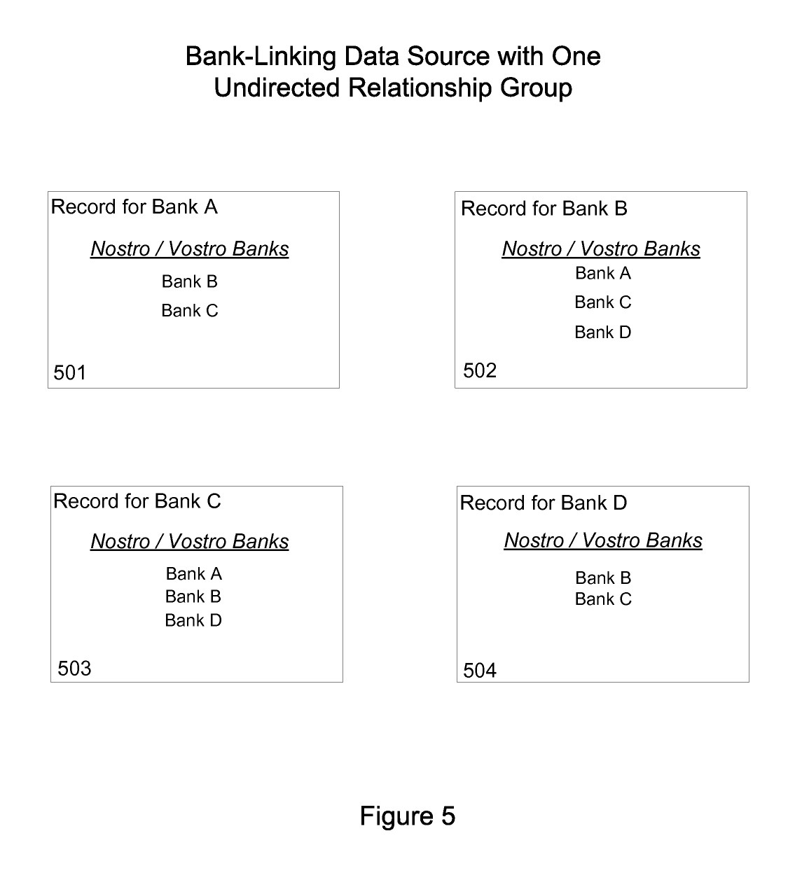

FIG. 5 shows an example of a Bank-Linking Data Source with an undirected relationship group. The relationship group in this figure is obtained by examining FIG. 4 and combining the vostro and nostro lists for each bank record. The nature of the nostro/vostro relationship means that when these lists are combined, the resulting Bank-Linking Data Source is undirected even though the two components that comprised the list both have directed relationships. The record for Bank A (501) has Bank B and Bank C on the ‘Nostro/Vostro’ relationship list. Similarly, the record for Bank B (502) has Bank A, Bank C, and Bank D on its ‘Nostro/Vostro’ relationship list. Moreover, the record for Bank C (503) has Bank A, Bank B, and Bank D on its ‘Nostro/Vostro’ relationship list. Finally, the record for Bank D (504) has Bank B and Bank C on its ‘Nostro/Vostro’ relationship list.

The relationship lists in FIG. 5 shows the unidirectional nature of the relationship. For example, the record for Bank A (501) indicates that Bank B is on its ‘Nostro/Vostro’ relationship list. Correspondingly, the record for Bank B (502) indicates that Bank A is on its ‘Nostro/Vostro’ relationship list. This reflexive property is true for each of the banks on a ‘Nostro/Vostro’ relationship list.

### Data Consistency in an Undirected Relationship Group of a Bank-Linking Data Source

An undirected relationship group in a Bank-Linking Data Source may have inconsistent data due to data entry errors. In an undirected relationship group, if Bank A appears on the relationship list of Bank B, then Bank B should appear on the relationship list of Bank A.

When a relationship group is identified as undirected in nature, the consistency of the data may be checked and data entry errors identified. For example, if it is known that the relationship group is undirected, if a first bank is on the relationship list of a second bank, then a consistency check may be performed by examining the relationship list of the first bank and verifying that the second bank is present.

A consistency check in an undirected relationship comprises the following steps:

1. Identifying a first bank
2. Examining the relationship list of the first bank
3. Identifying a second bank that is on the relationship list of the first bank
4. Examining the relationship list of the second bank
5. Verifying the first bank is on the relationship list of the second bank
6. Determining if the consistence check passes or fails. The check passes if the first bank is on the relationship list of the second bank. The check fails if the first bank is not on the relationship list of the second bank.

For a given first bank, a consistency check may be completed for every bank on the relationship list of the first bank. Furthermore, the entry for each bank may undergo a similar process. When each bank is examined, and each bank in the relationship list undergoes such a consistency check, the entire Bank-Linking Data Source is said to undergo a full consistency check.

When performing a consistency check or a group of consistency checks (not necessarily a full consistency check), any consistency checks that fail may be recorded. Failed consistency checks may be examined to determine the reason for the failure.

There are two principle reasons why a consistency check may fail. These two reasons are best demonstrated by example, although it is obvious to one skilled in the art that these may be generalized to a wide-variety situations.

Suppose an undirected relationship list of a first bank is under examination, and a second bank identified that is a member of the undirected relationship group for said first bank. Further suppose that the first bank is not on the undirected relationship list of the second bank. In this case, the consistency check fails.

One potential reason for the failure is that the first bank has been incorrectly left off or removed from the undirected relationship list of the second bank. In this case, data consistency may be recovered by adding the first bank to the undirected relationship list of the second bank.

A second potential reason for the failure is that the second bank has been incorrectly added to the undirected relationship list of the first bank. In this case, data consistency may be recovered by removing the second bank from the undirected relationship list of the first bank.

### Directed Graphs

A directed relationship appearing in a Bank-Linked Data Source may be represented with a directed graph (digraph). A directed graph is a graph where the edges between the vertices have directional indicators.

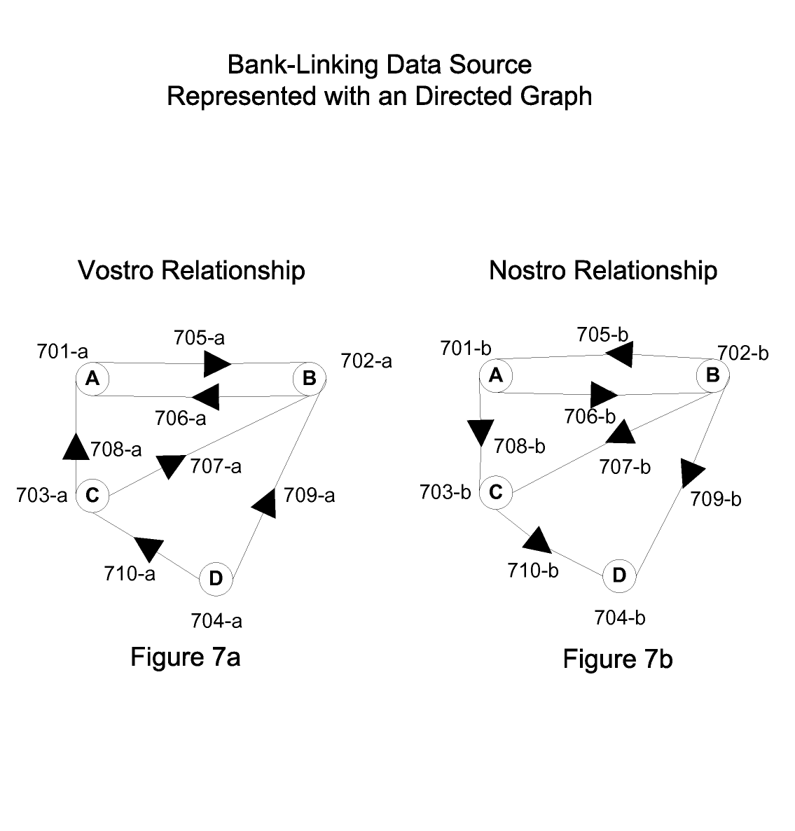

FIG. 7a provides an example of a digraph for the vostro relationships from FIG. 4. The record for Bank A is indicates as a circle with the letter ‘A’ inside (701-a). According to FIG. 4, Bank A has a vostro relationship with Bank B (401). In the figure, this relationship is indicated with an edge connecting Bank A (701-a) and Bank B (702-a), and where the edge contains an arrow (705-a) pointing from Bank A (701-a) to Bank B (702-a). Similarly, Bank B (702-a) has vostro relationships with Bank A (701-a), and this is indicated as an edge with an arrow (706-a) point from Bank B (702-a) to Bank A (701-a). Bank C (703-a) has vostro relationships with Bank A (701-a) and Bank B (702-a). These are indicated with the directed edges (708-a) and (707-a) respectively. Finally, Bank D (704-a) has vostro relationships with Bank C (703-a) and Bank B (702-a). These vostro relationships are indicated with the directed edges (710-a) and (709-a) respectively.

FIG. 7b provides an example of a digraph for the nostro relationships from FIG. 4. The record for Bank A is indicates as a circle with the letter ‘A’ inside (701-b). According to FIG. 4, Bank A has a nostro relationship with Bank B (401). In the figure, this relationship is indicated with an edge connecting Bank A (701-b) and Bank B (702-b), and where the edge contains an arrow (705-b) pointing from Bank A (701-b) to Bank B (702-b). Similarly, Bank B (702-b) has nostro relationships with Bank A (701-b), and this is indicated as an edge with an arrow (706-b) point from Bank B (702-b) to Bank A (701-b). Bank C (703-b) has nostro relationships with Bank A (701-b) and Bank B (702-b). These are indicated with the directed edges (708-b) and (707-b) respectively. Finally, Bank D (704-b) has nostro relationships with Bank C (703-b) and Bank B (702-b). These nostro relationships are indicated with the directed edges (710-b) and (709-b) respectively.

### Undirected Graphs

An undirected relationship in a Bank-Linking Data Source may be represented using an undirected graph. An undirected graph is a typical graph with vertices and edges where the edges do not have direction arrows.

FIG. g provides an example of a digraph for the nostro/vostro relationships from FIG. 5. The record for Bank A is indicates as a circle with the letter ‘A’ inside (601). According to FIG. 5, Bank A has a nostro/vostro relationship with Bank B. In the figure, this relationship is indicated with an edge (605) connecting Bank A (601) and Bank B (602). Furthermore, Bank A (601) has a nostro/vostro relationship with Bank C (603). This relationship is depicted in the figure as an edge (606) between Bank A (601) and Bank C (603). Similarly, Bank B (602) has nostro/vostro relationships with Bank A (701-b), Bank C (603) and Bank D (604). These relationships are indicated by edges (605), (607), and (609) respectively. Bank C (603) has nostro/vostro relationships with Bank A (601), Bank B (602), and Bank D (604). These are indicated with the edges (606), (607), and (608) respectively. Finally, Bank D (604) has nostro/vostro relationships with Bank B (602) and Bank C (603). These nostro/vostro relationships are indicated with the edges (609) and (608) respectively.

### Mapping Banking Separation at One Degree

Given a Bank-Linking Data Source, a first bank is considered separated at the one degree from a second bank if the record for the first bank indicates that the first bank has a relationship with a second bank. Alternatively, the second bank is considered separated at one degree from the first bank if the record for the second bank indicates that the second bank has a relationship with the first bank.

It should be appreciated that a first bank may be separated at one degree from a second bank, even though the second bank is not separated at one degree from the first bank. In this situation, the record for the first bank indicates a relationship with the second bank, but the record for the second bank does not indicate a relationship with the first bank.

As an example, consider a Bank-Linking Data Source wherein each bank has a record and the relationship is a list of nostro banks. If a first bank has a nostro relationship with a second bank, then the record for the first bank indicates that the second bank is on the nostro list of the first bank. Although the second bank is a vostro of the first bank, the second bank is not necessarily a nostro with the first bank. Since the relationship is only providing nostro relationships, the record for the nostro relationships for the second bank does not include the first bank. Hence, the first bank is one degree separated from the second bank on the nostro relationship list, but the second bank is not one degree separated from the first bank on the nostro relationship list.

FIG. 4 shows several relationships at one degree. For example, the record for Bank A (401) has a vostro relationship with Bank B. Thus, the Bank A is one degree separated from Bank B with respect to the vostro relationship group. Similarly the nostro record for Bank A (401) indicates relationships with Bank B and Bank C. Thus, Bank A is separated at one degree from both Bank B and Bank C with respect to the nostro relationship group.

From this example it should be appreciated that when a Bank-Linking Data Source has multiple relationship groups, banks may be separated by one degree with respect to one relationship group while not separated by one degree with respect to another relationship group. In the example, Bank A is separated at one degree from Bank C with respect to the nostro relationship group, but is not separated from Bank C at one degree with respect to the vostro relationship group. However, Bank A is separated from Bank B at one degree with respect to both the nostro and vostro relationship groups.

### Mapping Banking Separation at Two Degrees

Given a Bank-Linking Data Source, a first bank is considered separated at the two degrees from a second bank if the record for the first bank does not indicate that the first bank has a relationship with a second bank, but there exists a third bank that is on the list of related banks for the first bank, and where the second bank is on the list of related banks of the third bank.

A second degree relationship between a first and second bank may be construed as the first bank being ‘on hop’ from the second bank. Here, there is no direct relationship from the first bank to the second bank, but there is a third bank that acts as an intermediate between the two.

Similar to one degree relationships, it is possible that a first bank may be two degrees separated from a second bank, but the second bank is not two degrees separated from the first bank. Again, the directional nature of the relationships may lead to situations where there is a path from the first bank to the second bank that has exactly one intermediate, but there is no path from the second bank to the first bank with exactly one intermediate.

In fact, the second bank may even be directly connected to the first bank. In this case, the first bank may be two degrees separated from the second bank, while the second bank is only one degree separated from the first bank.

Alternatively, the second bank may in fact be two degrees separated from the first bank. Moreover the second bank may be further separated than two degrees. In fact, the second bank may not even be connected to the first bank at all leading to an ‘infinite’ separation from the second bank to the first bank, even though the first bank is two degrees separated from the second bank.

Again, the directional nature of the relationships between the banks may lead to different degrees of separation when the direction is from a first bank to a second bank when compared to examining the degrees of separation from a second bank to a first bank.

FIG. 4 provides an example of banks separated at two degrees. For example, the record for Bank A (401) indicates vostro relationship with Bank B. Moreover, the record for Bank B (402) indicates a vostro relationship with Bank D. Thus, Bank A and Bank D are separated at two degrees with respect to the vostro relationship.

### Mapping Banking Separation at Higher Degrees

The concept of degrees of separation may be extended to degrees higher than two. In general, a first bank is said to be separated from a second bank by N degrees when the shortest connection from the first bank to the second bank contains exactly N−1 intermediate banks.

As with one and two degrees of separation, higher degrees are directional. If a first bank is separated from a second bank at N degrees, this does not necessarily mean that the second bank is separated from the first bank at N degrees. The second bank may be separated from the first bank by one, two, N, infinite, or any other integer number of degrees.

### Directed Bipartite Graph

Given a Bank-Linking Data Source with a directed relationship, banks separated from a given bank at one or two degrees may be determined by examining a directed bipartite graph. A bipartite graph is a graph where the vertices may be separated into two groups. The vertices in the first group may have edges connecting them to vertices in the second group. However, vertices in the first group do not have edges connecting them to other vertices in the first group. Moreover, vertices in the second group do not have edges connecting them to vertices in the second group.

A directed bipartite graph is a bipartite graph wherein the edges connecting vertices is adorned with an arrow indicating directionality.

A directed bipartite graph may be formed from a Bank-Linking Data Source that contains a directed relationship group. First, a vertex of interest is identified. Then, using a directed relationship group, all connected vertices are identified. The vertex of interest in placed in a first group of vertices, while all of the connected vertices are placed in a second group of vertices. Next, for every vertex in the second group, all vertices in the relationship group of each of these vertices is placed into the first group, unless the vertex is already a member of the second group. Finally, a directed edge indicating the relationship is placed connecting members of the first group to the second group, or from the second group to the first group. However, no edges are placed between members of the first group even if a relationship exists. Furthermore, no edges are placed between members of the second group, even if a relationship exists.

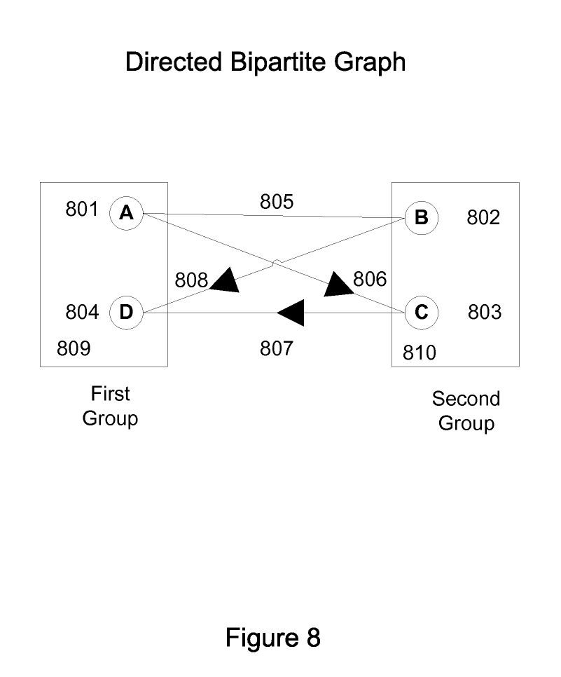

FIG. 8 shows a bipartite graph centered on node A (801). This graph was obtained from the nostro graph of FIG. 7b. From FIG. 7b, Bank A (701-b) is connected directly to both Bank B (702-b) and Bank C (703-b). Bank A (701-b) has two connections to Bank B (702-b), edge (705-b) and edge (706-b). In the corresponding bipartite graph, Bank A (801) is connected to Bank B (802) with a single edge (805) that does not have an arrow. This demonstrates one possible convention for directed graphs; namely, if two nodes are connected by directed edges in both directions, the two edges may be replaced with a single edge that does not have a directional arrow. In FIG. 7b, Bank A (701-b) is directly connected to Bank C (703-b) via edge (708-b). This translated to FIG. 8 as the directed edge (806) from Bank A (801) to Bank C (803). Bank B (802) is connected to Bank D (804), and a directed edge (808) from Bank B (802) to Bank D (804) is drawn. Similarly, a directed edge (807) is drawn from Bank C (803) to Bank D (804).

The origin bank, Bank A (801), is placed into the first group (809). The banks in Bank A (801) nostro relationship are placed into the second group (810). The banks that are in nostro relationship with these banks are placed in the first group (809). In this case, there is only one such bank, Bank D (804).

In this figure, there is no connection drawn from Bank B (802) to Bank C (803) even though there is a nostro connection between them in FIG. 7b (see element 707-b). Again, no connections are drawn between members of the same group.

From the digraph of FIG. 8, the first and second degree relationships to Bank A (801) are easily demonstrated. All members of the second group (810) are separated from Bank A (801) at one degree. All members in the first group (other than the origin node) are separated from Bank A (801) at two degrees.

### Undirected Bipartite Graph

Given a Bank-Linking Data Source with an undirected relationship, banks separated from a given bank at one or two degrees may be determined by examining an undirected bipartite graph. The vertices in the first group may have edges connecting them to vertices in the second group. However, vertices in the first group do not have edges connecting them to other vertices in the first group. Moreover, vertices in the second group do not have edges connecting them to vertices in the second group.

An undirected bipartite graph may be formed from a Bank-Linking Data Source that contains an undirected relationship group. First, a vertex of interest is identified. Then, using an undirected relationship group, all connected vertices are identified. The vertex of interest in placed in a first group of vertices, while all of the connected vertices are placed in a second group of vertices. Next, for every vertex in the second group, all vertices in the relationship group of each of these vertices is placed into the first group, unless the vertex is already a member of the second group. Finally, an undirected edge indicating the relationship is placed connecting members of the first group to the second group, or from the second group to the first group. However, no edges are placed between members of the first group even if a relationship exists. Furthermore, no edges are placed between members of the second group, even if a relationship exists.

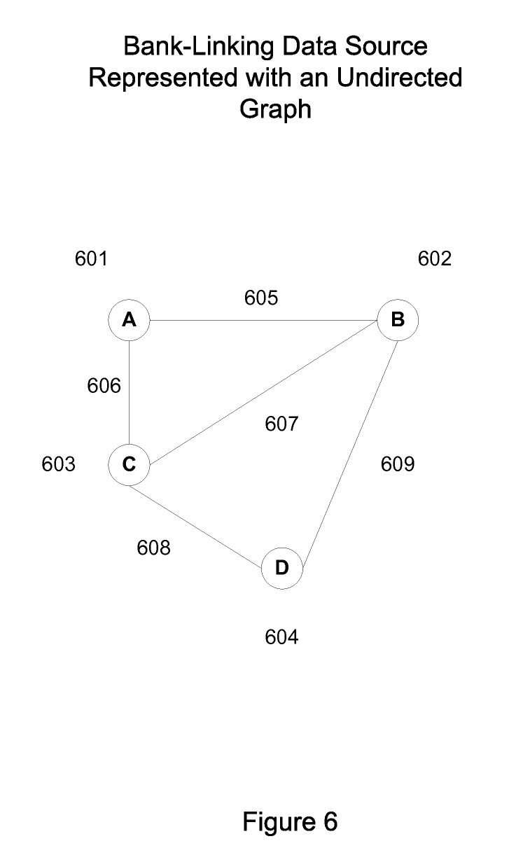

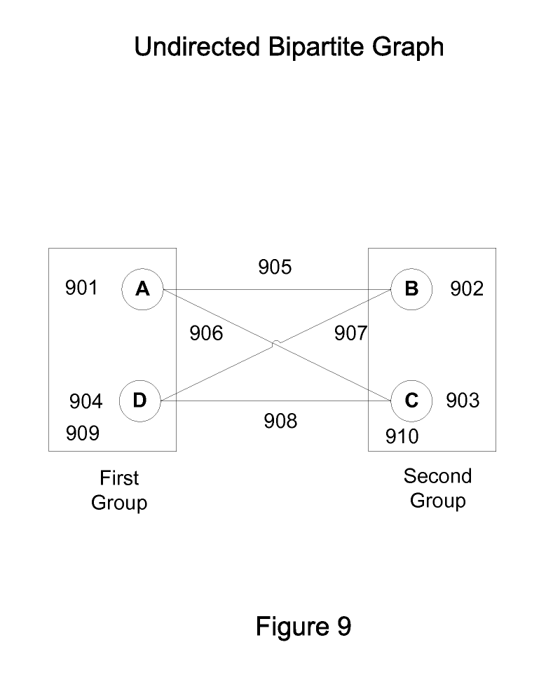

FIG. 9 provides an example of an undirected bipartite graph. FIG. 9 is constructed using the data from FIG. 6. Starting with Bank A (901) as the origin vertex, all banks connected directly to Bank A (601) in FIG. 6 are placed into a second group (910). From FIG. 6, both Bank B (602) and Bank C (603) are directly connected to Bank A (601). This translates in FIG. 9 to edges (905 and 906) connecting Bank A (901) to Bank B (902) and Bank C (903). Furthermore, since Bank D (604) is connected to Bank B (602), FIG. 9 shows an edge (907) connecting Bank B (902) to Bank D (904). Similarly, Bank C (903) has an edge (908) connecting Bank C (903) to Bank D (904).

Bank B (902) and Bank C (903) are placed into the second group (910) because both are directly connected to the origin bank, Bank A (901). Bank D (904) is placed into the first group (909) because Bank D (904) is connected to Bank B (902) and Bank C (903).

From the undirected bipartite graph, the bank separated from Bank A (901) at one and two degrees may be determined. All members of the second group (910) are connected to Bank A (901) at one degree. All members of the first group (909) (except Bank A itself) are connected to Bank A (901) at two degrees of separation.

### Bridge Banks

A graphical mapping of a Bank-Linking Data Source may be used to identify bridge banks. Bridge banks are a set of one or more banks that connect two distinct regions of the graph of a Bank-Linking Data Source.

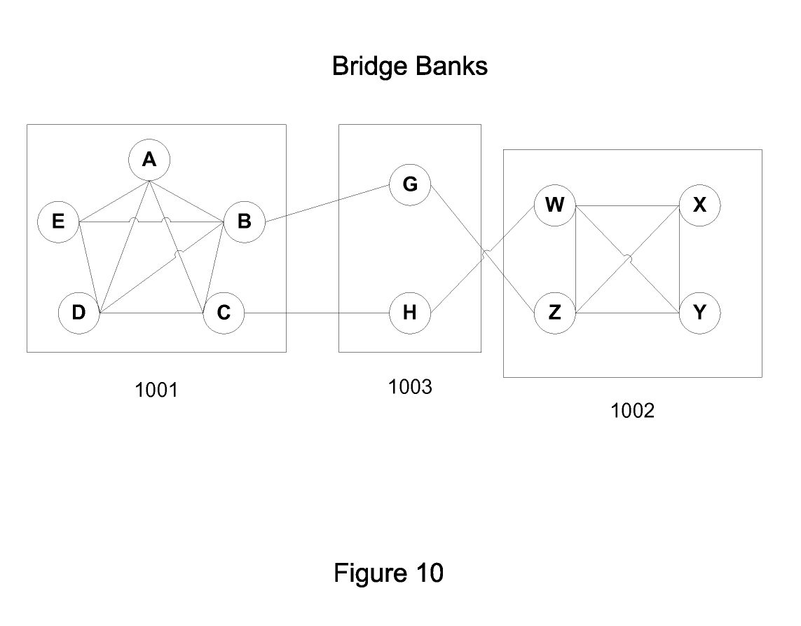

FIG. 10 provides an example of a Bank-Linking Data Source whose graph demonstrates bridge banks. In this figure, there exists a first group of banks (1001) that are connected among themselves. Further, there is a second group of banks (1002) that are connected among themselves. The two groups are connected to each other via a set of bridge banks (1003). If the bridge banks were eliminated, the graph would separate into two pieces that are not connected.

Identifying bridge banks may be useful in some regulatory environments. Identifying a small set of banks that facilitate the connection between two distinct groups of banks may indicate banks that are the focal point for some illicit activity.

### Financial Transactions Not Required

An important advantage of mapping a Bank-Linking Data Source at one degree, two degrees, higher degrees, or with directed or undirected graphs, is that relationships at various levels may be identified even in the absence of financial transactions between the banks. A Bank-Linking Data Source may be used to find degrees of separation between banks even when there is no flow of transactions connecting these banks.

An examination of transaction flow between banks is limited in the relationships that may be detected. Banks will only be linked when a financial transaction flows between the banks. Using a Bank-Linking Data Source, these transactions may still be detected. This may be accomplished by using a relationship group that is a financial transaction.

However, a Bank-Linking Data Source is not limited to merely financial transactions. A Bank-Linking Data Source may contain more general information (such as vostro and nostro relationship groups) that allows the mapping and discovery of relationships between banks that would be missed using only financial transactions.

### Data Updates

It should be appreciated that a Bank-Linking Data Source may benefit from regular updates and/or refreshing of the data contained in the relationships. Moreover, updates may add entirely new bank records, or may remove stale records.

Data updates may be provided as a regular event, or may occur in real-time as new information becomes available. Moreover, a system may be employed that is capable of both regular updates and real-time updates. For example, a system may provide regular updates for most of the data, but employ real-time updates for frequently changing data. By combining these data update models together, the system is able to keep fast changing data current without needing to provide real-time updates for the entire data source.

### Automation Via Computer Systems

It should be appreciated that a Bank-Linking Data Source may benefit from automation via computer systems. A computer hardware and software system may provide access to a Bank-Linking Data Source. In fact, the embodiments detailed in this application may be implemented in a software system.

Automating a Bank-Linking Data Source in a software system may be accomplished in a few steps. First, the Bank-Linking Data Source is provided in machine readable form. This may exist as records in a relational database, records in an object oriented database, records in a flat-file data base, or as one or more files containing bank information and related relationship group information.

Second, an automated system may incorporate a capability to automatically compute degrees of separation between any two banks in a Bank-Linking Data Source. A Bank-Linking Data Source may contain in excess of one hundred thousand bank records. Computing the degree of separation between two arbitrary banks may be an extremely time-consuming task. By automating this process in a computer system, the task may be performed on a regular basis to determine if the degree of separation between two banks changes. This feature may be very useful when considering regulatory compliance.

Third, an automated system may have capabilities for creating and analyzing directed graphs, undirected graphs, directed bipartite graphs, undirected bipartite graphs, or other graphs of interest. Automating the generation and analysis of these graphs is useful as a means to present information to users.

Fourth, an automated system may have capabilities for automatically examining the consistency of an undirected relationship group in a Bank-Linking Data Source. Automating this capability provides an example of the flexibility of software systems. The process of conducting a full consistency check of an undirected relationship group may take N² operations when there are N bank records. Software systems are ideal for automating such a process to quickly identify any failures in consistency and reporting those results to a user.

It should be appreciated that the information output in this section may be presented as a printed document, as an on-screen representation, or as an electronic output such as a file, email, or text message.

### Incorporation to a Computer System

The above embodiments may be enhanced by use of a computer system. There are many ways a computer system may incorporate these embodiment. For example, a computer system may print a Bank Network Graph to a computer screen. Moreover, any of the graphs described above may be printed to a computer screen or to a printing device capable of rendering a diagram on paper.

### Regulatory Compliance

Banking regulations such as the Comprehensive Iran Sanctions, Accountability, and Divestment Act of 2010 (CISADA) demonstrate the need for mapping a Bank-Linking Data Source. Such banking regulations require banks to know who their customers are, and who are the customers of their customers (i.e. correspondent's correspondents).

The embodiments of the present invention support capabilities for mapping a Bank-Linking Data Source and may be used to examine compliance with banking regulations such as CISADA. By mapping a Bank-Linking Data Source, relationships between banks in violation of CISADA may be identified and reported to a customer or user.

I claim:

1. A method of graphically determining the degree of separation between banks comprising of the steps:
a. Identifying a Bank-Linking Data Source specifying at least two relationship groups containing correspondent banking information where the Bank-Linking Data Source contains both nostro and vostro relationship groups;
b. Identifying an origin bank;
c. Identifying a destination bank;
d. Creating a Bank Network Graph wherein the vertices on the graph represent banks, and wherein two vertices are connected with an edge if the banks corresponding to the vertices have a correspondent banking relationship, and wherein the edge is adorned with an arrowhead;
e. A method for determining the minimum separation degree between the origin bank and the destination bank using the correspondent relationship group in the Bank-Linking Data Source, wherein the method for determining the minimum separation degree comprises directed graphs;
f. and producing a written report comprising the origin bank, destination bank, and the minimum degree of separation between the origin bank and destination bank.

2. The method of claim 1 where the arrowhead points from the vertex corresponding to the account owner to the vertex corresponding to the account holder.

3. The method of claim 1 where the arrowhead points from the vertex corresponding to the account holder to the vertex corresponding to the account owner.

4. The method of claim 1 with the additional step of identifying Bridge Banks.

5. A method of creating a Bank Network Graph comprising of the steps:
a. Identifying a Bank-Linking Data Source specifying at least one relationship group containing correspondent banking information;
b. Drawing a vertex for each unique bank in the Bank-Linking Data Source;
c. Connecting two vertices when the banks corresponding to the vertices have a correspondent banking relationship;
d. Printing the output graph on a computer screen.

6. The method of claim 5 wherein arrows are added to each edge indicating if the correspondent relationship between the banks is a nostro or vostro relationship.

7. A method of identifying correspondent banking relationship comprising of the steps:
a. Identifying a Bank-Linking Data Source specifying at least one relationship group containing correspondent banking information;
b. Identifying an origin bank;
c. Identifying a destination bank;
d. A method for determining the minimum separation degree between the origin bank and the destination bank using the correspondent relationship group in the Bank-Linking Data Source, wherein the method for determining the minimum separation degree comprises directed graphs;
e. and producing a written report comprising the origin bank, destination bank, and the minimum degree of separation between the origin bank and destination bank.

8. The method of claim 7 where the relationship group is a nostro relationship.

9. The method of claim 7 where the relationship group is a vostro relationship.

10. The method of claim 7 with the additional step of identifying Bridge Banks.
